(19) United States
(12) Patent Application Publication
(10) Pub. No.: US 2007/0296179 A1
(43) Pub. Date: Dec. 27, 2007

(54) BICYCLE ACCESSORY MOUNT

(76) Inventors: Jeff Orr, Tucson, AZ (US); Wes Wilkinson, Tucson, AZ (US); Brian Grasky, Tucson, AZ (US)

Correspondence Address: HAYES SOLOWAY P.C., 3450 E. SUNRISE DRIVE, SUITE 140, TUCSON, AZ, 85718, US

(21) Appl. No.: 11/766,772

(22) Filed: Jun. 21, 2007

Related U.S. Application Data
(60) Provisional application No. 60/805,839, filed on Jun. 26, 2006.

(51) Int. Cl. B62J 39/00

(52) U.S. Cl. 280/288.4

(57) ABSTRACT

A bicycle accessory mounting device includes an accessory mounting portion, first and second support members, and a bicycle steerer tube attachment fixture. An accessory may be mounted to the accessory mounting device using a strap, hose clamp or other attachment device. The first and second support members connect the accessory mounting bar to the bicycle steerer tube attachment fixture, which is attached to the steerer tube of a bicycle by means of a bolt, rivet, nut or other device.

### CROSS REFERENCE TO RELATED APPLICATION

This application claims priority from U.S. Provisional Patent Application Ser. No. 60/805,839, filed Jun. 26, 2006, the contents of which are incorporated herein by reference.

### FIELD OF THE INVENTION

The present invention generally relates to an accessory mount for a bicycle. More particularly, the present invention relates to an accessory mount for attachment to the steerer tube of a bicycle.

### BACKGROUND OF THE INVENTION

Bicycling is a popular pastime. During the activity, bicyclers often have a need for carrying various devices. On many bicycles, the cyclist may have one or more rear view mirrors attached to the handlebars, just forward of the handle grips. In addition, a cyclist may have a horn or light attached to the handlebars by suitable clamps. In recent times, cyclists have carried additional items such as music-playing devices, computers, timers, sensors, and the like.

Moreover, carriers have been developed for placement over the front or rear wheels, with such carriers having braces attachable to the front or rear axles, respectively. Other such devices include baskets formed of wire for attachment to the front handlebars in a manner in which the basket extends over the front wheel. The mounting of devices such as computers and media players onto a bicycle is well known in the art. Because such devices must be oriented and located appropriately such that the rider may view and access them while riding, they are often equipped with straps, hose clamps or other means of attachment to the handlebars of a bicycle.

FIG. 9 illustrates a portion of a bicycle 900. The bicycle 900 includes a steerer tube 910 and female threads 920. Female threads 920 are housed inside the steerer tube 910. In certain embodiments, female threads 920 may be a feature of a star fangled nut housed inside the steerer tube. A timer or the like 930 is mounted to the handlebars 940.

However, in certain instances it is not desirable or possible to mount a device to the handlebars. For example, attachment of a device to a set of aero bars often creates an obstruction to the rider, makes the device inaccessible to the rider, or is simply impossible. Further, metal hose clamps and similar devices for attachment to handlebars may scratch the bicycle.

Thus, a need has long existed for an apparatus that allows a rider to mount a device to the steerer tube of the bicycle where mounting the device to the handlebars is either disadvantageous or impossible, such that the device is within the view and accessible range of the rider. A need has further existed for such a device that allows the attachment and removal of an accessory using its associated strap, hose clamp or other means designed for attachment to a handlebar, such that the accessory may be attached and removed without disassembling any portion of the bicycle.

### BRIEF SUMMARY OF THE INVENTION

One or more of the embodiments of the present invention provide a bicycle accessory mounting device including an accessory mounting bar, first and second support members, and a bicycle steerer tube attachment fixture. An accessory is mounted to the accessory mounting bar using a clamp, a strap, hook and loop, a hose clamp, string, rope, cord, a bungee cord, or other apparatus. The first and second support members connect the accessory mounting bar to the bicycle steerer tube attachment fixture, which is attached to the steerer tube of a bicycle by means of a bolt, rivet, nut or other apparatus.

### BRIEF DESCRIPTION OF THE DRAWINGS

FIG. 1 illustrates a perspective view of a bicycle accessory mount according to an embodiment of the present invention;

FIG. 2 illustrates a plan view of the bicycle accessory mount of FIG. 1;

FIG. 3 illustrates an elevational view of the bicycle accessory mount of FIG. 1;

FIG. 4 illustrates a cross-sectional view of the bicycle accessory mount along the IV-IV axis of FIG. 2;

FIG. 5 illustrates a cross-sectional view of the bicycle accessory mount along the V-V axis of FIG. 4;

FIG. 6 illustrates a cross-sectional view of the bicycle accessory mount along the VI-VI axis of FIG. 4;

FIG. 7 illustrates a rear view of the bicycle accessory mount of FIG. 1;

FIG. 8 illustrates a cross-sectional view of the bicycle accessory mount along the VIII-VIII axis of FIG. 4; and

FIG. 9 illustrates a portion of a bicycle showing the mount attached to the bicycle.

### DETAILED DESCRIPTION OF THE INVENTION

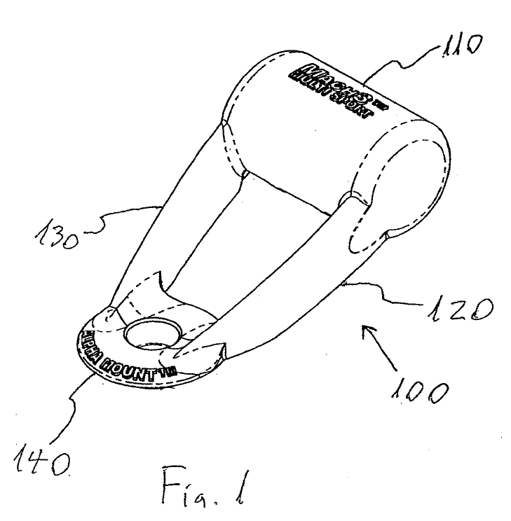

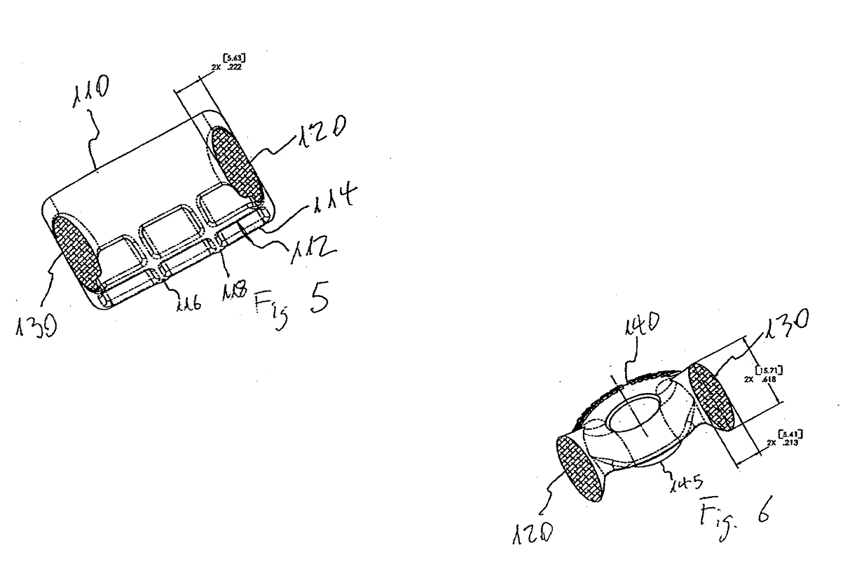

FIGS. 1-8 illustrate an accessory mounting device 100 according to an embodiment of the present invention. The accessory mounting device 100 includes an accessory mounting portion 110, a first support member 120, a second support member 130, and a bicycle steerer tube attachment fixture 140. First support member 120 is connected at one end to the accessory mounting portion 110 and at the other end to the bicycle steerer tube attachment fixture, which in a preferred embodiment comprises an annulus 140. Second support member 120 is connected at one end to the accessory mounting portion 110 and at the other end to the bicycle steerer tube attachment annulus 140.

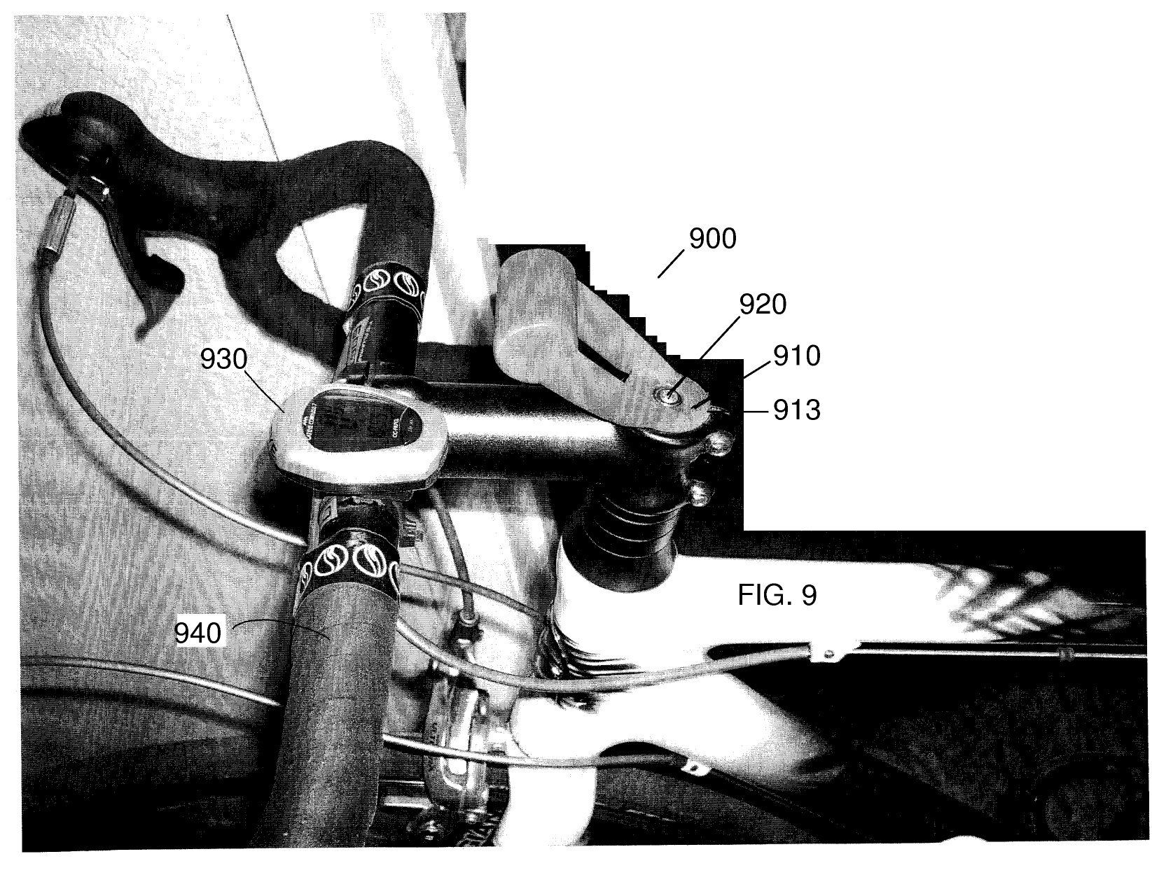

In use, the bicycle steerer tube attachment annulus 140 is attached to the steerer tube of a bicycle 900 (FIG. 9). The first support member 120 and the second support member 130 hold the accessory mounting portion 110 at a distance from the bicycle steerer tube attachment annulus 140. A resulting space between the accessory mounting portion 110 and the bicycle steerer tube attachment annulus 140 allows a user to attach an accessory to the accessory mounting portion 110 by means of a strap, hose clamp, or other attachment device. The first and second supporting members are aerodynamically shaped such that air flowing over them produces minimal drag force on the bicycle.

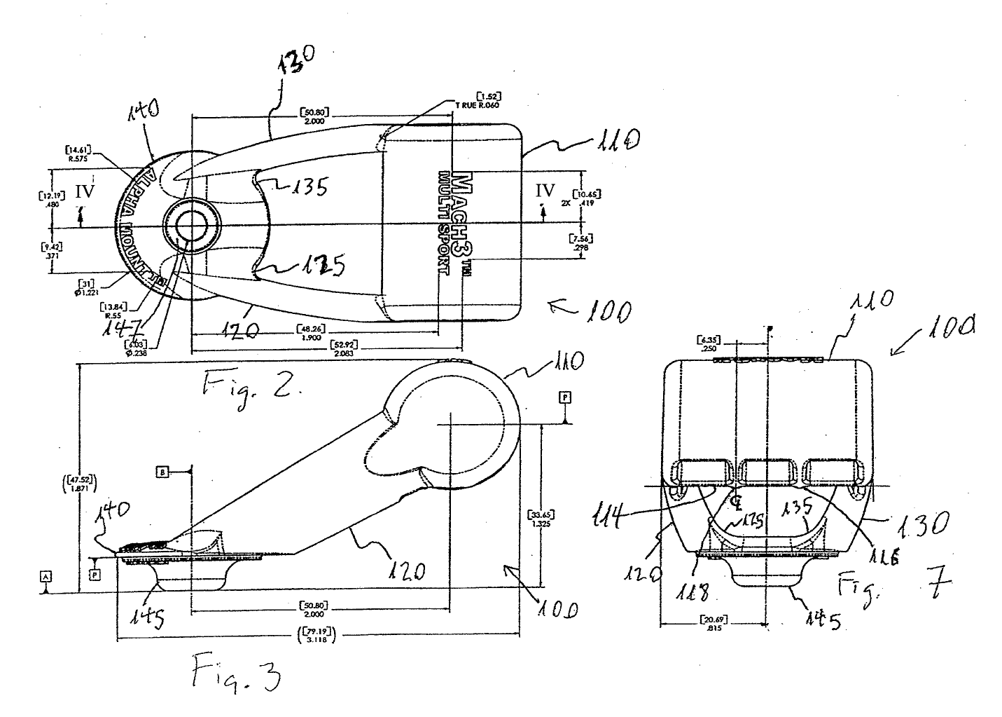

Referring to FIG. 2, the accessory mounting device 100 includes a first fillet 125, a second fillet 135, and a bolt supporting ridge 147. The fillet 125 connects the first support member 120 to the bicycle steerer tube attachment annulus 140. The fillet 135 connects the second support member 130 to the bicycle steerer tube attachment annulus 140. The bolt supporting ridge 147 is a feature of the bicycle steerer tube attachment annulus 140.

Referring to FIG. 3, the accessory mounting device 100 includes a steerer tube fitting extrusion 145. The steerer tube fitting extrusion 145 is a feature of the bicycle steerer tube attachment annulus 140.

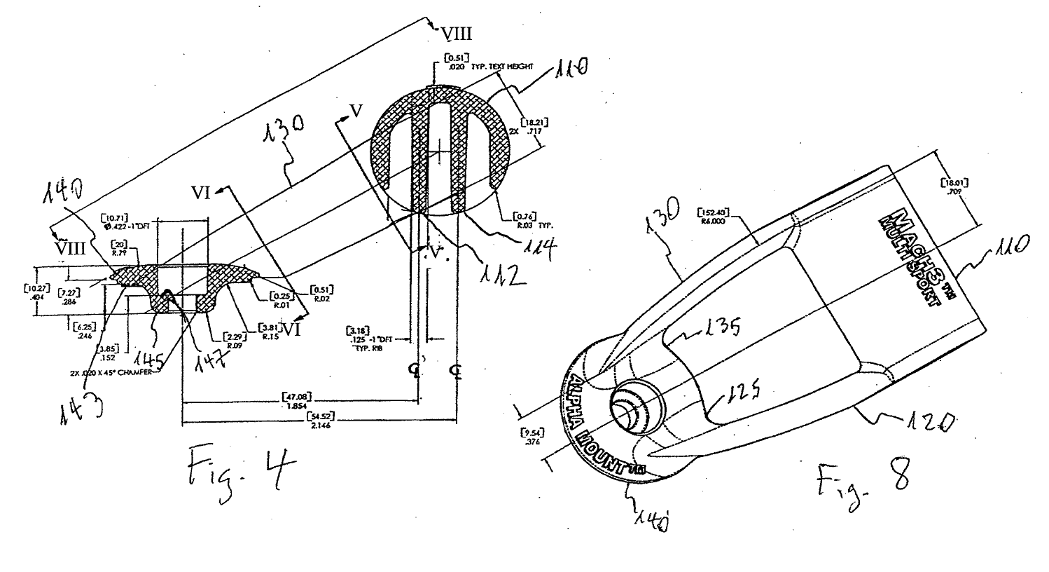

Referring to FIG. 4, the accessory mounting device 100 includes an attachment supporting lip 143, a steerer tube fitting extrusion 145, a bolt supporting ridge 147, a first lateral panel 112, and a second lateral panel 114. The attachment supporting lip 143, the steerer tube fitting extrusion 145, and the bolt supporting ridge 147 are features of the bicycle steerer tube attachment annulus 140. The first lateral panel 112 and the second lateral panel 114 are features of the accessory mounting portion 112.

To mount the accessory mounting device 100 to a bicycle, a bolt (not shown in FIG. 4) is inserted into the bicycle steerer tube attachment annulus 140. The bolt is supported by the bolt supporting ridge 147. Next, the bolt and the steerer tube fitting extrusion 145 are inserted into the steerer tube 910 (FIG. 9) of a bicycle 900 (FIG. 9). The attachment supporting lip 143 rests either on the steerer tube itself or on the stem 913 (FIG. 9) attached the steerer tube. Next, the bolt engages female threads 920 (FIG. 9) within the steerer tube 910 of the bicycle 900 and is tightened such that the accessory mounting device 100 is securely attached to the steerer tube of the bicycle 900.

The first vertical panel 112 and the second vertical panel 114 provide support for the mounting of an accessory to the accessory mounting portion 110.

Referring also to FIG. 5, the accessory mounting device 100 includes a first headlong panel 116 and a second headlong panel 118.

The first and second headlong panels provide support for the first and second lateral panels, and provide additional support for the mounting of an accessory to the accessory mounting portion 110. The combination of the headlong and lateral panels require less material than would be required if the accessory mounting portion 110 were a solid cylinder of material.

The invention is susceptible to modification. For example, in one embodiment of the present invention, only one supporting member 120 is used to support the accessory mounting portion 110. In another embodiment, one continuously curved piece replaces the supporting members and the accessory mounting portion. In yet another embodiment, one continuously curved piece having a continuous cross-section replaces the supporting members and the accessory mounting portion. In another embodiment, the support members are cylindrically shaped.

Also, if desired, the support members 120, 130 may be oriented downward instead of upward such that the accessory mounting portion 110 is lower than the bicycle steerer tube attachment annulus 140. Alternatively, the support members may be oriented such that the accessory mounting portion 110 is level with the bicycle steerer tube attachment annulus. Also, if desired, the first and second support members may be rotatably connected to the bicycle steerer tube attachment annulus 140 so that the angle of the support members with respect to the bicycle steerer tube attachment annulus may be adjusted. In yet another embodiment, the accessory mounting portion 110 may be rotatably attached to the support members such that a user may adjust the orientation of the accessory attached to the accessory mounting portion.

Further, if desired, the support members 120, 130 may be altered such that a user has the option to make them longer or shorter. For example, each support member may individually multiple portions linked using a telescoping mechanism, a sliding linkage, linear bearings or other means such that they may slide relative to one another.

Typically, the accessory mounting device 100 is oriented such that the accessory mounting portion 110 is farther from the rider than the bicycle steerer tube attachment annulus 140. However, the accessory mounting device 100 may be oriented such that the accessory mounting portion 110 is closer to the rider than the bicycle steerer tube attachment annulus 140. And, if desired, the attachment annulus 140 may be mounted on the steerer tube of the bicycle such that the accessory mounting device 100 may be freely rotated and locked into any orientation.

Also, if desired, the bicycle steerer tube attachment annulus 140 may be replaced with a bicycle steerer tube attachment portion having a clip, strap, hose clamp or other means for attachment to a portion of the bicycle, such as the top tube, down tube or stem. In yet another embodiment, the bicycle steerer tube attachment annulus 140 is replaced with a bicycle steerer tube attachment portion.

In one embodiment of the present invention, the accessory mounting portion 110 is adapted to be attached to the steerer tube of a bicycle using a threaded shaft such as a bolt or screw.

In another embodiment, the accessory mounting portion 110 is adapted with female threads such that an accessory may be mounted to it using a screw or other attachment means. In yet another embodiment, the accessory mounting portion 110 may be fitted with receiving portions allowing a user to insert an attachment member associated with an accessory.

The first support member 120 and the second support member 130, the steerer tube attachment annulus 140 and/or the accessory mounting portion 110 may be hollow. Also, the accessory mounting portion 110 is fitted with slats such that air flows through as well as around the accessory mounting portion.

The accessory mounting device 100 may be made of a metal, such as aluminum such as 513 cast aluminum, or titanium, or it may be made of graphite, or a plastic such as polyvinyl chloride, a polyethylene base material such as P-tex or other commonly commercially available plastic, rubber, carbon, carbon fiber, wood, foam or foam rubber, or a combination of the materials listed above.

If desired, the accessory mounting portion 110 may be covered, at least in part, with a cloth material, an array of fibers such as a portion of carpet or rug, rubber and/or plastic.

While the preferred embodiments of the present invention have been illustrated in detail, various modifications and adaptations to those embodiments may be made in the invention without departing from the scope of the present invention as set forth in the following claims. For example, the accessory mounting device 100 may be made to be attached to the steerer tube of a motorcycle.

1. A bicycle accessory mount including:
an accessory mounting portion;
a bicycle steerer tube attachment portion; and
a support member connecting said accessory mounting portion to said bicycle steerer tube attachment portion wherein said bicycle steerer tube attachment portion is adapted to attach to the steerer tube of a bicycle.

2. The bicycle accessory mount of claim 1, wherein said accessory mounting portion is roughly of a cylindrical shape.

3. The bicycle accessory mount of claim 1, wherein said accessory mounting portion is adapted for the attachment of an accessory using an attachment apparatus selected from the group consisting of a clamp, a strap, hook and loop, a hose clamp, string, rope, cord, and a bungee cord.

4. The bicycle accessory mount of claim 1, wherein said accessory mounting portion is partially hollow.

5. The bicycle accessory mount of claim 2, wherein said accessory mounting portion is partially hollow.

6. The bicycle accessory mount of claim 3, wherein said accessory mounting portion is partially hollow.

7. The bicycle accessory mount of claim 1, further including a second support member connecting said accessory mounting portion to said bicycle steerer tube attachment portion.

8. The bicycle accessory mount of claim 1, wherein said bicycle steerer attachment portion is an annulus.

9. The bicycle accessory mount of claim 1, wherein said support member is slotted to allow air to flow over its surface with minimal drag force.

10. A method of attaching an accessory to a bicycle, said method comprising the steps of:
inserting a threaded shaft into an aperture in said accessory; and
inserting said threaded shaft into a set of female threads provided on the steerer tube of a bicycle.

11. A method of attaching an accessory to a bicycle, said method comprising the steps of:
inserting a threaded shaft into an aperture in a fixture provided with a roughly cylindrical portion; and
attaching the accessory to said roughly cylindrical portion.
